(19) United States
(12) Patent Application Publication
(10) Pub. No.: US 2007/0106578 A1
(43) Pub. Date: May 10, 2007

(54) Financial data management system and method

(76) Inventor: Thie Jurjen Knigge, Zuidhorn (NL)

Correspondence Address: MICHAELSON & ASSOCIATES, P.O. BOX 8489, RED BANK, NJ, 07701, US

(21) Appl. No.: 11/267,036

(22) Filed: Nov. 4, 2005

(51) Int. Cl. G06Q 40/00

(52) U.S. Cl. 705/35

(57) ABSTRACT

An financial data management system. The system includes a first input for receiving a first set of financial data from a first data source and a second input for receiving a second set of financial data from a second data source. A first interface unit is connected to the first input, for converting the first set in a format readable by a data consolidation unit. A second interface unit is connected to the second input, for converting the first set in a format readable by a data consolidation unit. The system has a data consolidation unit for comparing the first and second financial data and generating consolidated data based on the comparing. The system further has an output for outputting the consolidated data.

### FIELD AND BACKGROUND OF THE INVENTION

The invention relates to an financial data management system and method. The invention further relates to a data carrier provided with program code and to a data carrier on which data obtainable with an financial data management system are stored.

In the financial industry, operations are typically based on financial information about assets, e.g, stock price, information about the turnover of a company etc. In order to ensure the accuracy of data, securities firms or other financial institutes are very careful about choosing trusted sources of information.

The sources of financial data may include primary sources, such as exchanges or corporate issuers, data consolidators and resellers (also referred to as data vendors), industry-owned utilities such as depositories, other firms and internal sources such as an institution's own systems which may originate proprietary financial data, such as details of derivatives trades. Data vendors, e.g. like Bloomberg, Telekurs and Financial Times Interactive Data Corporation (FTID), provide a wide variety of data feeds to the financial community. Data vendors also differentiate themselves by focusing on specific financial instruments. Therefore, in order to obtain a complete coverage, financial institutes have to use multiple sources of financial data. Most financial institutes also generate and maintain internal proprietary data, such as original trade data for derivatives created for investor clients which provides valuable information in addition to the financial data from external sources.

In order to increase the reliability of the financial data, a financial institute may obtain financial data about the same asset from two or more sources and use a so called ‘financial data management system’ to compare the financial data from different sources and to determine any discrepancies in the financial data. Based on this comparison of financial data, suitable values for the financial data about the asset is determined The thus determined set of financial data is referred to as consolidated data. The collection of consolidated data is referred to as the ‘golden copy’. The golden copy thus includes data about a large number of assets and may then be used in operations of the financial institute, e.g. to base decisions about buying or selling in a stock market.

However, comparing the data from different sources and generating the golden copy, is a complex operation since the formatting, structure and information contained in the financial data differs for each source of data. To provide a suitable financial data management systems, the financial data management system may be custom-made to merge data from different sources into consolidated data. However, a disadvantage thereof is that such a system lacks flexibility.

### SUMMARY OF THE INVENTION

It is one goal of the invention to provide a financial data management system that is more flexible. Therefore, according to the invention, a system according to claim 1 is provided.

Such a system is more flexible since the first and second (and all additional) financial data sources are converted by the interfacing unit into data readable by a data consolidation unit. Thus, in case sources are added, removed or changed, the system can be adapted in a simple manner by adding and/or, removing and/or replacing a corresponding interfacing unit and/or adjusting the consolidation unit

Furthermore, a method according to claim 13 is provided. The invention also provides a data carrier according to claim 14. The invention further provides financial data according to claim 15.

Specific embodiments of the invention are set forth in the dependent claims.

### BRIEF DESCRIPTION OF THE DRAWINGS

Further details, aspects and embodiments of the invention will be described, by way of example only, with reference to the drawings.

FIG. 1 schematically shows a block, diagram of an example of an embodiment of a system according to the invention.

FIG. 2 shows a flowchart of an example of a method according to the invention.

FIG. 3 schematically shows a block diagram of an example of an embodiment of an interface unit according to the invention.

FIG. 4 schematically shows a block diagram of an example of an embodiment of a data normalization unit according to the invention.

FIG. 5 schematically shows a block diagram of an example of an embodiment of a data consolidation unit according to the invention.

### DETAILED DESCRIPTION

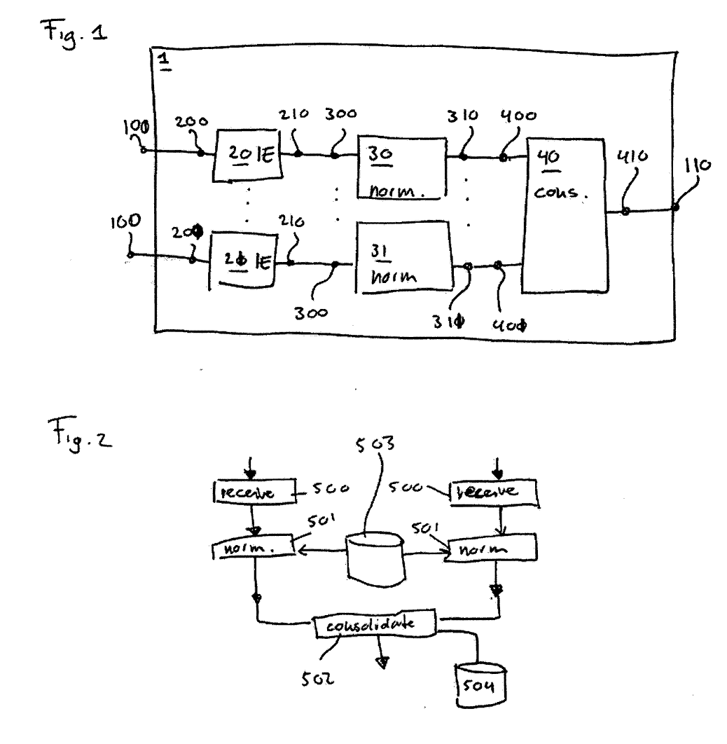

The example of a system 1 shown in FIG. 1 includes at least two system inputs 100,101. Each of the inputs 100,101 is connected to an input 200 of an interface unit 20,21. The interface units 20,21 are connected with their engine outputs 210 to respective inputs 300,301 of normalization units 30,31. The normalization units 30,31 each have normalization outputs 310,311 which are connected to consolidation inputs 400-401 of a consolidation unit 400. The consolidation unit 400 has a consolidation output 410 at which consolidated data is output. The consolidation output 410 is connected to a system output 110.

The system 1 of FIG. 1 is able to perform an example of a method according to the invention. FIG. 2 shows a flow-chart of a suitable method. Initially, in step 500 financial data is received from different sources of financial data. E.g. one or more sets of financial data about assets, issuers, counterparties or other objects that are meaningful in a business context are received.

In the following, it is assumed that from each source one set of financial data is received and that the sets of financial data relate to the same, specific object, e.g. a specific company or a specific stock or other financial instrument. However, from each source of financial data, two or more different sets of financial data may be received. For example, each set of financial data may also relate to a different financial asset, e.g. one set may relate to a stock X and another set may relate to another stock Y, etc.

In the example of FIG. 1, the interface units 20,21 convert the received sets of data into respective objects with attributes, asxis explained below in more detail. An object describes financial information with a conceptual existence, for example a stock or a company. An object has attributes that describe particular properties of the object. From hereon an object generated from a received set of financial data is referred to as a financial object.

For example, at a first interface unit 20 a first set of data may be received from a first data vendor A which contains information about a stock Y, whereas at a second interface unit 21 a second set of data may be received from a second data vendor B which also contains information about the stock Y. The first set may then be converted in a first financial object representing the stock Y and the second set may be converted in a second financial object representing the stock Y as well. The first financial object and the second financial object may then be provided with attributes. The values of the attributes are filled using the ‘raw’ information in the respective sets of financial data.

The financial objects are normalized in step 501, based on a normalization data model (NDM) stored in a normalization data model memory 503. The normalization in step 501 generates a normalized object with normalized attributes and normalized attribute values. In the example of FIG. 1 for instance, the normalization is performed by the normalization unit 30,31 for each financial object separately.

The normalization unit 30,31 may for instance maps the attributes and attribute values of the financial object to normalized attributes and normalized attribute values based on a set of mapping rules for the type of financial object, e.g. for the specific source and type of asset represented by the object. However, the set of mapping rules to be applied in the normalization unit may be selected or determined in a different manner.

For example, the attributes of financial objects relating to the same type of asset but from different sources are typically different. The mapping rules may map the attributes to a set of (predefined) normalized attributes for the type of asset. The set of normalized attributes is the same for the financial objects from different sources, but the values of the normalized attributes may, of course differ.

To that end, the normalization unit 30,31 may for instance include a memory 503 in which a set of mapping rules is stored for each type of financial object, e.g. for each asset and each source. The mapping rules are constructed in such manner that the normalized objects derived from comparable objects from different sources have the same types of normalized attributes and the values of the normalized attributes are in the same units.

However, it is also possible that in the memory 503 for each type of attribute a specific mapping rule is stored. Thereby, redundancies in the mapping rules are reduced since various types of financial object may use a same type of attribute, e.g. such as the ISIN (International Securities Identification Number). A mapping rule may therefore be present to map an attribute of a type ISIN to a normalized attribute may be stored in the memory 503. In the step 501, the types of attributes of a financial object may be determined and from the memory 503 the stored mapping rules associated with the attribute types maybe selected and applied to determine the normalized attributes and normalized attribute values.

For instance, the first financial object may be mapped to a first normalized object while the second financial object may be mapped to a second normalized object. The first and second normalized objects may then have the same types of attributes but with different values. However, the units in which the attribute values are expressed are comparable. For instance, in case the first and financial object relate to a stock Y, the first financial object may have an attribute ‘stock price’ expressed in Euros whereas the second financial object may have an attribute ‘value’ expressed in US dollars. The memory 503 may then contain a first set of mapping rules and a second set of mapping rules. The first set of mapping rules may map the attributes and values of financial objects of a type similar to that of the first object to a normalized object, and for example map the attribute ‘stock price’ expressed in Euros to a normalized attribute ‘share price’ in US dollars. The second set of mapping rules may map the attributes and values of financial objects of a type similar to that of the second object to a normalized object, and for example map the attribute ‘value’ to a normalized attribute ‘share price’ in US dollars. Thus, the values of the attributes of the normalized objects originating from different sources can be compared, whereas typically the received sets of data cannot be compared since each data vendor uses its own conventions in describing and formatting the financial data.

After normalization, the normalized objects originating from different sources but relating to the same type of asset, e.g. stock Y, are consolidated in step 502 into consolidated objects. In the example of FIG. 1, the consolidation of the objects is performed by the consolidation unit 40. In step 502, the attributes of the normalized objects from different sources but relating to the same type of asset are processed using consolidation rules stored in a consolidation memory 504. For example, the values of the attributes of the normalized objects may be compared and depending on a result of this comparison, a value of an attribute of a consolidated object may be determined.

E.g. a first normalized object representing stock Y may have an attribute ‘stock price’ set to a first value n and a second normalized object representing stock Y may have an attribute ‘stock price’ with a second value p which differs from the first value n. The consolidation rule may then be that the value of the attribute ‘stock price’ of the consolidated object is set to the average value of the attributes ‘stock price’ of the normalized objects, or that the value of the first normalized object has to be used. After consolidation, the consolidated objects are output as the ‘golden copy’ and can be used downstream processes, for example providing input data to risk management systems, asset management systems, financial trading systems or other suitable types of systems.

The interface units 20,21 may be implemented in any manner suitable for the specific implementation. The system 1 may be provided with a different, dedicated interface unit 20,21 for each different source of financial data. The interface units 20,21 may be configured to receive from a source different types of set, for example relating to different types of assets. E.g. typically a source of data provides different types of sets, for example relating to stock, to assets etc. However, for the sake of simplicity, only two interface units 20,21 are shown in FIG. 1 and it is assumed that a financial data about a single type of asset is received.

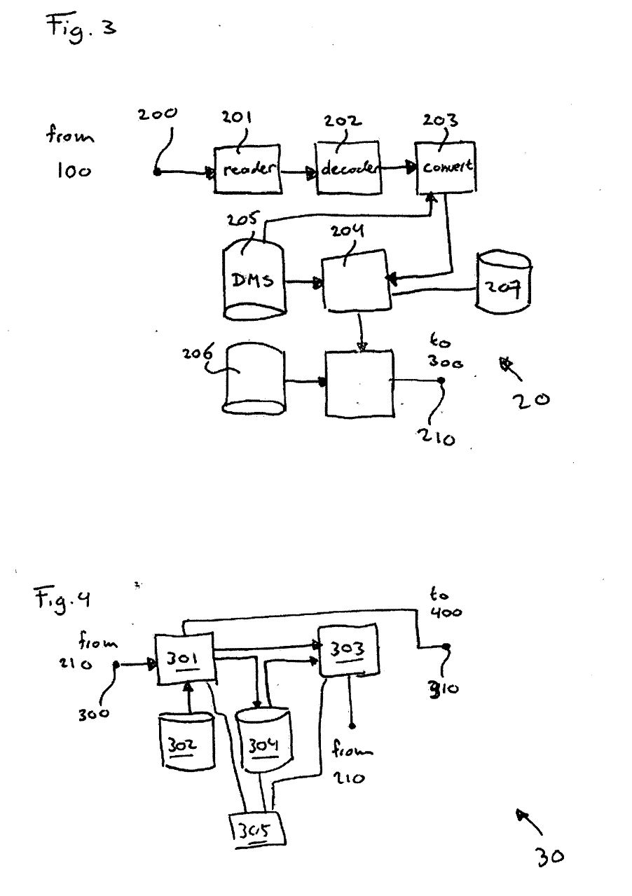

FIG. 3 shows an example of an interface unit 20 suitable for the example of FIG. 1. The interface units may, inter alia, be arranged to check the received set financial data against at least one second predetermined criterion associated with the specific data source and to perform a predetermined action in response to a result of this check. For instance, in this example the interface unit 20 checks the structure of the data in the received set against one or more criteria and does not check the informational content of the data. More specific, in this example the structure of the data is checked against the specifications for the data defined by the source of the data. Data that does not adhere to the specifications of the data source is rejected. Thus, the reliability of the data is improved.

The example of FIG. 3 includes an interface input 200 at which a set of financial data from a selected source, e.g. Bloomberg, can be received. The received set is provided to a reader 201 connected to the interface input 200. The reader 201 reads the set of data and translates the received data into a translated set of data, which set of data can be read by a data model unit 204. The set of financial data may e.g. be provided as a text file with a certain structure and in the reader 201 information about this structure is stored and used to derive the information from the set of data.

The system 1 may include a number of interfacing units 20,21 each dedicated to a specific type of set and/or a specific source. The reader 201 may then be provided with information about the structure of a specific type of set, e.g. a set from ascertain source about a specific type of financial assets (such as a set from Bloomberg about NASDAQ shares). The set of data from a specific source may for instance be organized in a specific manner. For example, the set of data may be organized in blocks in the text file and each block may be a separate line of the text idle. The reader 201 may then search the text file for an end-of-line character and start reading a block at the character position directly after the end-of-line character. Each block may then start with a code representing a specific aspect and subsequently information about that specific aspect. For instance, a block starting with a code A1 may represent the name of a stock and the name may be the field directly next to the code, separated by a comma: e.g. the block may be ‘A1, intrusion inc’. The reader may then read the text file, detect the code ‘A1’ and store a variable named ‘A1’ with a value equal to the string directly following the code A1, e.g. ‘intrusion inc’. The reader 201 outputs the determined variables and their values to a decoder 202.

The reader 201 is connected with its output to an input of-a decoder 202. The decoder 201 compares the structure of the received data against a set of rules for the structure and adjusts the structure of the received data in case the received data does not comply with the structure rules. In doing so the formatting of the data from the reader is standardized to a certain extent and the chance that values are interpreted erroneously in the further processing is reduced. The decoder 201 maybe arranged to compare the structure of the received data only, without comparing the content of the received data. The decoder 202 may for instance format the data received from the reader 201 in a common format. For example, the decoder 202 may ensure that the same type of decimal separator is used. e.g. commas and may ensure that the same formatting is used to indicate data and time, e.g. year-month-date. Furthermore, the decoder 202 may add the value N/A (not available) to the variable in case the reader 201 outputs an attribute without values.

The decoder 202 is connected to a converter 203. The converter 203 checks the data from the decoder against at least one or more criteria. For example, the converter 203 may check whether a certain variable has a value of the correct type (e.g. an integer), whether the variable corresponds to an attribute defined in a data model 205. In case the variable does not comply with the criteria, for example in case the variable should be of a type integer and the actual value is a floating point type, the variable can for instance be marked in order to indicate a reduced reliability or other measures may be taken. The converter 203 further converts each variable into an attribute. To that end, the converter 203 compares the variable with a list of attributes of a data model and selects an attribute from the list that corresponds to the variable.

The converter 203 outputs the attributes to a model generator 204. The model generator 204 instantiates a model-object based on a data model stored in a data model system (DMS) memory 205. For each different type of set, a specific data model may be present in the memory 205 and the model generator 204 may select a data model based on the type of asset and the source of the set of financial data. E.g. a first model may be selected for the set of financial about data stock Y from vendor A, and a second model may be selected for the set of financial about data stock Y from vendor B.

The model-object has attributes. In the model generator 204, the attributes are associated with respective attributes output by the converter 203 and the value of these attributes of the model-object is set to the value of the associated attributes output by the converter 203. In case an attribute of the model-object cannot be associated with an attribute outputted by the converter 203, the value of the attribute of the model-object is marked as N/A: not available. The model generator 204 outputs the model-object to a model-processing unit 207.

The model processing unit 207 can process the model-object to generate additional information, based on the attributes of the model-object and a set of rules in a model processing memory 206. This processing may also be referred to as enriching the model-object. The model processing unit 207 thus generates additional data based on the financial data represented by the model object and enhances the information content of the received financial data.

For example, the model-processing unit 207 may associate one or more attributes of the model-object with attributes of other model-objects. E.g. in case the model-object represents a stock, the model-processing unit may associate the model-object with another model-object which represents the company. Also, the model processing unit 207 may generate additional information by performing calculations with one or more attribute values. The model processing unit 207 may further check the model-object against one or more criteria. The model processing unit 207 may, for example, execute a rule which determines inconsistencies in the data. Such a rule may for example determine whether the name of a stock exchange corresponds to the place of the exchange where the stock is traded or other logical inconsistencies. The model processing unit 207 may further mark one or more of the attributes as unreliable, for example in case there is a logical inconsistency or in case an attribute has a value which is not likely (e.g. a stock price which exceeds a certain threshold).

The model-processing unit 207 outputs the enriched model-object at an interface output 210. The interface output 210 is connected to a normalization unit 30,31.

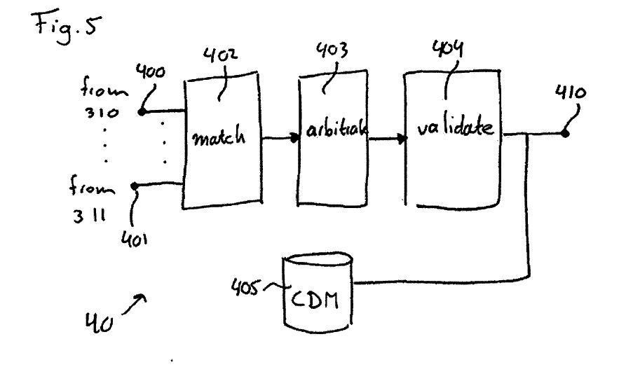

The normalization unit 30,31 may be implemented in any manner suitable for the specific implementation. In the example of FIG. 1 only a single normalization unit is shown, however a separate normalization unit may be provided for each-interface unit 20,21. FIG. 4 shows an example of a normalization unit 30 suitable for the example of FIG. 1. The example includes a normalization input 300 connected to a normalization processor 301. The normalization processor 301 receives the enriched model-object via the normalization input 300 and generates a normalized model object based on normalization rules stored in a normalized model memory 302. For each type of attribute, one or more specific normalization rules may be stored in the memory. A normalization rule may also use one, two ore more attributes of the enriched model object to generate a normalized attribute or generate one, two or more normalized attributes. For example, for the attribute ‘stock exchange’ a set of transformation rules maybe stored in the memory 302, which map different values of an attribute to a single unique normalized value. For example, in the memory 302 a rule may be stored which transforms different names of a stock exchange (NYSE, Wall Street etc.) into a single name (e.g. New York Stock Exchange). The normalization processor 301 may store the normalized model object in a memory 304 and output the normalized model object to the consolidation unit 40. The normalization processor 301 may further store in a memory 204 information about the relationship between attributes of the enriched model object and the attributes of the normalized object. This information may for instance include on which attributes of the model-object the value of a normalized attribute depends.

The normalization processor may be arranged to mark normalized attributes as ‘suspect’, for example in case there are inconsistencies in the attributes of the model object. For instance, in case a value of an attribute of the model object is not present in a mapping table with possible values for-that attribute, the normalization processor 301 may mark the corresponding normalized attribute as suspect. As is explained below, the marking of the normalized attributes with an indication of reliability may be used to correct or adjust the financial data and thereby enhance the reliability.

As shown in FIG. 4, the normalization 30 unit may include a normalization trigger unit 303 which receives a trigger message from the interface unit 20 in case a value of the model-object or of the enriched model object changes. For instance, the interface unit 20 may after initialization determine an initial model object and include a memory in which the initial (enriched) model object is stored. The interface unit 20 may output the trigger message to the normalization trigger unit 303 in case, during operation, a set of data, which results in a change to the initial model object, is received. For example, initially the interface unit 20 may receive an initial set of financial data related to a stock Y. From the initial set a certain stock price is determined. Later in time a successive set of financial data related to the stock Y is received with a new stock price, but which leaves the other aspects of the stock unchanged. The interface engine 20 may then detect a change in the attribute ‘stock price’ of the model object and send a trigger message to the normalization unit 30. In response to the trigger message, the normalization unit 30 normalizes the attributes of the normalized object linked to the stock price again. For example, the normalization trigger unit 303 may receive from the interface unit 20 information about the changed attribute of the model object and retrieve from the memory 304 which normalized attributes are associated with the changed attribute. The normalization trigger unit 303 may then activate the normalization processor 301 to normalize the associated normalized attributes again. The normalization unit 30 may further output a successive trigger message to the consolidation unit 40 in response to which the consolidation unit 40 consolidates the attributes of the consolidated object associated to the changed normalized attributes of the normalized object. Thus, the normalization trigger unit 303 allows an adjustment of a part of the financial data represented by the normalized object only. Thereby, the system 1 can adapt in a relatively short period of time to changes in the received financial data.

It is possible that the normalization trigger unit 303 activates the normalization processor 301 to adjust an attribute of a normalized object in response to a change in an attribute of the same normalized object. However, it is also possible that normalization trigger unit 303 activates the normalization processor 301 to adjust a first attribute of a normalized object in response to a change in a second attribute of another, normalized object, for example to adjust an attribute of a normalized object representing a company in response to a change in a normalized object representing a stock of that company. The adjustment to the first attribute may in turn trigger an adjustment of a third attribute, etc. This chain of adjustment may be of any level (e.g object level or attribute level )and any complexity suitable for the specific implementation. For example, the first, second and third attribute may be attributes of the same financial object or may be attributes of different financial objects.

The normalization trigger unit 303 may be connected to a loop detector 305 in order to determine any loops in the chain. The loop detector 305 increases stability of the system, since closed loops, and corresponding instability aspects, can be detected and accordingly prevented or set in such a manner that the loop terminates.

The loop detector 305 may for example be arranged to maintain a listing of attributes modified after receiving the trigger signal. In case the trigger unit 303 receives the trigger signal, the normalization processor 301 determines which attributes are related to the changed attribute. The normalization processor 301 transmits an identification to the loop detector 305. The loop detector 305 may compare then the attribute to be modified with the data in the list, in order to determine whether the attribute has already been modified or not.

In case the loop detector 305 determines that the attribute has been modified, the loop detector 305 transmits a message to the normalization processor 301 in response to which the normalization processor terminates the normalization.

In case the loop detector 305 determines that the attribute is not listed on the listing, the loop detector 305 adds an identifier for that attribute to the list. The loop detector 305 further retrieves from the memory 304 which attributes within the object are directly associated to the attribute of that object that is to be modified. The loop detector 305 compares each of these associated attributes with the listing. In case an associated attribute is already listed, no further action is performed. In case an associated attribute is not listed, the associated attribute is determined again and an identifier for that associated attribute is added to the listing. In case a first associated attribute B₁ is dependent on another associated attribute B₂, the other associated attribute B₂ is determined first and then the first associated attribute B₁ is determined. In case the other associated attribute B₂ is dependent on the first associated attribute B₁, the loop detector will determine that the first associated attribute B₁ is listed. Not available will then be used as a value for the first associated attribute B₁ to determine the second associated attribute B₂. Thus, endless loops are prevented.

After the associated attributes have been determined, in case the values of the associated attributes have not changed no further action are performed. In case the values of one or more associated attributes have changed, the process described above is performed again with attributes associated to the associated attributes. This process is repeated until the attributes of the object do not change anymore.

After the associated attributes in the same object as the changed attribute which triggered the redetermination have been evaluated, the attributes in other objects that are associated with the changed attribute are determined as described above.

The consolidation unit 40 may be implemented in any manner suitable for the specific implementation. Consolidation of data between different sources results in more reliable data. Because of the consolidation data from different sources can be compared and, for example the best value can be chosen as the Golden Copy value. Furthermore, consolidation allows integration of data that is unique for individual data vendors, resulting in a more complete set of data that may be indispensable for conducting business.

FIG. 5 shows an example of a consolidation unit 40 suitable for the example of FIG. 1. The consolidation unit 40 includes a number of, in this example two, consolidation inputs 400,401. At the consolidation inputs 400,401, normalized objects are received from the normalization units 30,31. The normalized objects received at the inputs 400,401 are transmitted to a matching unit 402. The matching unit 402 generates a consolidated object by selecting from the normalized objects selected attributes using a predefined matching rule. The matching rule may for example be that in case the normalized objects have a number of comparable attributes a preferred one of the attributes is selected. For instance in case the normalized object includes different identifiers for the same stock, such as the International Securities Identification Number (ISIN), the Committee on Uniform Securities Identification Procedures number (CUSIP) or the Stock Exchange Daily Official List number (SEDOL), the rule may be that the ISIN attribute is selected if available, else the CUSIP attribute is selected if available, and if neither an ISIN nor an CUSIP attribute is available, the SEDOL attribute is selected if available.

The matching unit 402 transmits the consolidated object to an arbitration unit 403. The arbitration unit 403 determines the values of the consolidated attributes from the values of the selected normalized attributes. Thus, after normalization attributes are selected in the matching unit 402, in the arbitration unit 403 the value of the attribute is set. The arbitration unit may for that purpose apply a predetermined arbitration rule. The arbitration rule may for example be that for an attribute the value from a normalized object originating from a specific source has to be selected and if this normalized object does not have this attribute value, the value from a normalized object originating from another source is selected. However, other arbitration rules are also possible, for example that the consolidated value is the value occurring the most in the normalized objects, or that the consolidated value is calculated from the normalized values, e.g. by taking the average of the normalized values. Other arbitration rules are also possible.

The arbitration unit 403 also marks the consolidated attribute with a status that can be used to represent an indication of the reliability of the consolidated value. For example, in case a consolidated value is set to the normalized value of a normalized object originating from a specific source, but normalized objects originating from a other sources have a different value, the consolidated value may be considered less reliable (and be marked accordingly) than in case all normalized objects have the same value. Based on the marking, an exception process may be initiated, for example by putting the consolidated attributes marked as not reliable into an operator queue for manual inspection.

The arbitration unit 403 is, as shown in FIG. 5, connected with its output to a validation unit 404. The validation unit 404 checks the attributes of the consolidated object for inconsistencies. In the example, the validation unit 404 and the arbitration unit 403 are shown as separate units and perform separate steps. However, it is also possible that the validation unit 404 and the arbitration unit 403 are integrated in a single unit which can perform a combined validation and arbitration procedure.

For example, the validation unit 404 may check the value of a consolidated attribute itself. For example, the format of value of the attribute may be compared with a rule or threshold. E.g. that the value of a consolidated attribute ‘share price’ is below a certain threshold value.

The validation unit 404 may also check the value of a consolidated attribute to be consistent with other values of consolidated attributes of the same consolidated object. For example, the validation unit 404 may check if a consolidated attribute ‘previous issue date’ has indeed a value which lies before the value of a consolidated attribute ‘issue date’.

The validation unit 404 may also check the value of a consolidated attribute to be consistent with values of consolidated attributes of other consolidated objects. For example, the validation unit 404 may check if an attribute ‘equity’ of an object representing e.g. a cash dividend (DVCA), scrip dividend (DVSC) or stock dividend (DVSE), is associated with an attribute ‘identifier’ of another consolidated object, and whether this consolidated object has an attribute ‘type’ with a value ‘equity’. The validation unit 404 may be arranged to resolve inconsistencies automatically or output m to a queue for manual inspection and verification by an operator of the system 1. For example, consolidated attributes which are found to be inconsistent, may be provided with a marking ‘suspect’ and be output at a user-interface.

The consolidation unit 40 may be provided, as shown in FIG. 5 with a consolidation trigger unit 406. The consolidation trigger unit 406 may keep a record of the relationship between consolidated attributes and normalized attributes. In the example of FIG. 5, the consolidation trigger unit 406 is connected to the normalization trigger unit 303. The normalization trigger unit 303 transmits a trigger signal to the consolidation trigger unit 406 in case a normalized attribute is changed. In response to this trigger signal, the consolidation trigger unit determines from the record which consolidated attributes are associated with the changed normalized attribute and triggers the consolidation unit 30 to perform the consolidation process for the consolidated attributes associated with the changed normalized attribute.

The normalization trigger unit 303 and the consolidation unit 406 allow an update of the consolidated data as soon as the received set of financial data changes. Thereby, the consolidated data can vary in time and the consolidated data is more time accurate. In this respect, the trigger mechanism may be implemented in a different manner. In this respect, it should be noted that this trigger mechanism may also be arranged to detect the addition or removal or change of a source of data and activate the units 20-40 to perform one or more steps of the process in response to the detected change.

The interfacing units 20,21, the normalization units 30,31 and the consolidation unit 40 may be provided with respective object memories 207,304 and 405. In the object memories 207,304,405 the data about an assets after a respective phase, e.g. normalization or consolidation, of the process can be stored, e.g. the financial object, the normalized object and the consolidated object. Thereby, reliability of the data can be increased, since no information is lost and accordingly verification of the entire process is possible.

The invention is not limited to implementation in the disclosed examples of devices, but can likewise be applied in other devices. In particular, the invention is not limited to physical devices or units implemented in non-programmable hardware but can also be applied in programmable devices or units able to perform the desired device functions by operating in accordance with suitable program code. Furthermore, the devices may be physically distributed over a number of apparatuses, while logically regarded as a single device. Also, devices logically regarded as separate devices may be integrated in a single physical device. For example, the interface units 20,21, the normalization unit 30,31 and the consolidation unit 40 may be implemented as a single processor programmed to perform the functions of the respective units. Also, for example, the validation unit and the arbitration unit may be implemented in a single unit.

The invention may also be implemented in a computer program for running on a computer system, at least including code portions for performing steps of a method according to the invention when run on a programmable apparatus, such as a computer system or enabling a programmable apparatus to perform functions of a device according to the invention. Such a computer program may be tangibly embodied in a data carrier, such as a CD-ROM or diskette, stored with data loadable in a memory of a computer system, the data representing the computer program or any other type of article of manufacture suitable for the specific implementation. The data carrier may further be a data connection, such as a telephone cable or a wireless connection transmitting signals representing a computer program according to the invention.

In the foregoing specification, the invention has been described with reference to specific examples of embodiments of the invention. However, various modifications and changes may be made. The specifications and drawings are, accordingly, to be regarded in an illustrative rather than in a restrictive sense.

1. A financial data management system, including:
at least a first input for receiving a first set of financial data from at least one first data source;
at least a second input for receiving a second set of financial data from at least one second data source;
a first interface unit connected to said first input, for converting said first set in a format readable by a data consolidation unitdation unit;
a second interface unit connected to said second input, for converting said first set in a format readable by a data consolidation unitdation unit;
a data consolidation unit for comparing the first and second financial data and generating consolidated data based on said comparing; and
said system further including an output for outputting the consolidated data.

2. A system according to claim 1, wherein at least one of said first interface unit, said second interface unit, and said data consolidation unit is arranged for checking the received financial data against at least one predetermined criterion and for marking or adjusting the financial data based on said criterion.

3. A system according to claim 1, wherein each of said first and second interface unit includes a converting unit for converting the structure of the first financial data and the second financial data to a standardized structure.

4. A system according to claim 3, wherein the converting unit is connected to an error checking unit for checking the converted first financial data and/or the second financial data for formatting errors.

5. A system according to claim 1, wherein said first and/or second interface unit includes a data enrichment unit for generating additional data based on the first set or second set of financial data.

6. A system according to claim 1, further including a detector for detecting a change in at least one aspect of the received first or second financial data and activating the data consolidation unit for consolidating an aspect of the consolidated data corresponding to the changed part.

7. A system according to claim 1, further including a first normalization unit connected to said first interface unit, for converting the first set of received financial data into a first set of normalized data and a second normalization unit connected to said second interface unit, for converting the second set of received financial data into a second set of normalized data, said first and second set of normalized data conforming to a common standard.

8. A system according to claim 7, wherein said normalization unit includes a memory for storing information about the relationship between a set of received data and a set of normalized data.

9. A system according to claim 7, wherein the normalization unit is further arranged to mark at least a part of the set normalized data with an indication of reliability.

10. A system according to claim 1, wherein said data consolidation unit includes a matching unit for selecting from the first and second set of normalized data at least one type of consolidated data and wherein said data consolidation unit further includes an arbitration unit for determining a value of the at least one selected types of consolidated data.

11. A system according to claim 1, wherein a set of data has a conceptual meaning in a business context.

12. A system according to claim 11, wherein the set of data represents a financial instrument, such as a stock, a bond, an interest rate, etc.

13. A method for managing financial data, including:
receiving first financial data from at least one first data source;
receiving second financial data from at least one second data source;
converting said first set in a format readable by a data consolidation unit;
converting said second set in a format readable by a data consolidation unit;
comparing the first and second set of financial data and generating consolidated data based on said comparing, and outputting the consolidated data.

14. A data carrier on which data is stored, said data representing program code executable by programmable apparatus, for performing a method as claimed in claim 13 when running on said programmable apparatus.

15. A data carrier on which data obtainable with a system according to claim 1 is stored.
